(19) United States
(12) Patent Application Publication
(10) Pub. No.: US 2018/0179084 A1
(43) Pub. Date: Jun. 28, 2018

(54) AUTO DIAGNOSTIC SENSOR BASED WATER PURIFICATION SYSTEM

(71) Applicant: Rakhi SINHA, New Delhi (IN)

(72) Inventor: Rakhi SINHA, New Delhi (IN)

(21) Appl. No.: 15/558,565

(22) PCT Filed: Mar. 17, 2016
(86) PCT No.: PCT/IB2016/051501

§ 371 Date: Sep. 17, 2017

(30) Foreign Application Priority Data
Mar. 17, 2015 (IN) 729/DEL/2015

(51) Int. Cl. C02F 1/00

(52) U.S. Cl. CPC C02F 1/008; C02F 2209/001; C02F 2209/006; C02F 2209/008; C02F 2209/02; C02F 2303/14; C02F 2209/06; C02F 2209/10; C02F 2209/11; C02F 2209/40; C02F 2209/03

(57) ABSTRACT

An auto diagnostic sensor based water purification system is disclosed in the present invention. The system includes a water purification unit adapted to purify the contaminated water, a plurality of sensors placed within the said water purification unit and a micro controller unit (MCU) connected with the said plurality of sensors. The plurality of sensors is adapted to detect a plurality of water property parameters and provide an output data to the said MCU. The MCU is adapted to process the said output data and send it to a remotely located diagnostic device. The said remotely located diagnostic device monitors a malfunctioning condition of the said water purification system and provides a set of diagnostic instructions to auto diagnose the said water purification system. The system further includes a notification module adapted to notify the output data from the said MCU to a user of the said water purification system.

### FIELD OF THE DISCLOSURE

The present invention relates to the field of water purification monitoring, and particularly, the present invention provides a water purification system capable of remotely monitored and diagnosed by a remotely located diagnostic device. More specifically, the present invention relates to a water purification system which is auto diagnosed via a communication network.

### BACKGROUND OF THE DISCLOSURE

Water is the main component of existence of life on planet earth. Major part of our planet earth is covered with water which is present in various forms such as oceans, lakes, rivers, and glaciers. However, the major portion of water on earth is contaminated with various kinds of unwanted materials and components such as salt, microorganisms, mud, organic materials, metals, non-metals, inorganic materials and other poisonous substances. Hence, this major part of contaminated water as present on earth is not suitable for human and animal consumption.

Only the fresh and pure water is useful for human and animal consumption. Further, the sources of fresh and pure water are very limited on planet earth and due to industrial revolution around the world the said sources of fresh and pure water are also shrinking day by day. Further, the environmental pollution had already contaminated most of the natural sources as well as natural process of fresh and pure water.

Accordingly, the water purification systems are very common in use to purify the contaminated water. These water purification systems are either very big in size or are very compact in size depending on their use. These water purification systems are made up of different type of water treatment components such as water sedimentation components, filtration membrane components, ultraviolet components, reverse osmosis components, mineral dispenser components, odour treatment components, pH correction component, taste improvement component, and/or a color treatment component. All these components are arranged in series to work in conjugation with each other. Further, the malfunction of any of the above component hampers the complete water purification process. Hence, it is very important to keep a regular check on the functioning of each of the above component.

Therefore, most of the time the maintenance engineers as deployed to regularly check the malfunctioning of the water purification systems. If the maintenance engineers get any clue of the malfunctioning of the water purification systems then they have to check each and every water treatment component. Finally the diagnostic team is called to replace the damaged water treatment component. This whole process of regular checking, then sending the report to the diagnostic team and finally treating and replacing the damaged water treatment component is very tedious, time consuming as well as costly. Thus this process hampers the regular supply of the fresh and pure water.

On the other hand, the regular supply of fresh and pure water is the main purpose of installation of such water purification systems. Moreover, the regular supply of fresh and pure water is the demand of every household. Accordingly, there is a need of a water purification system which is capable of maintaining the regular supply of fresh and pure water along with the diagnoses of each water treatment component.

Sometime, there are very small issues in the water purification systems such as water pressure/flow, which if not treated at the initial point leads to the permanent damage of the other costly water treatment component. Hence, this process of regular maintenance of the water purification system leads to the higher service cost for the end consumer.

Accordingly, there is a need of a water purification system which is capable of maintaining the regular supply of fresh and pure water along with reduced the service time as well as the entire service and maintenance cost of the water purification system.

Further, there is a demand of a water purification system which eliminates the need of deploying a large number of service engineers, maintenance engineers, along with the diagnostic team members for the regular checking and maintenance of the water purification system.

Further, there is a need of a water purification system having automation features of detecting and notifying its own malfunctioning conditions to a user as well as to a remotely located diagnostic device.

Furthermore, there is a need of a water purification system capable of receiving auto diagnostic instructions from the user or from a remotely located diagnostic device.

### SUMMARY

In view of the aforesaid needs and shortcomings in the state of the art, in an aspect, the present invention provides an auto diagnostic sensor based water purification system.

It will be apparent to a person skilled in art that the present water purification system is adapted to notify its own malfunctioning condition to a remotely located diagnostic device. Further, the remotely located diagnostic device is adapted to provide a set of diagnostic instructions to auto diagnose the said water purification system. The said diagnostic instructions are provided as per the malfunctioning condition of the water purification system. The invention therefore achieves the following objects, among many.

The present invented water purification system includes a water purification unit adapted to purify the contaminated water. The said water purification unit is made up of one of a water treatment component. The said water treatment component is selected from at least one of a filtration membrane component, an ultraviolet component, a reverse osmosis component, a mineral dispenser component, an odour treatment component, a pH correction component, a taste improvement component, or a color treatment component, or a combination thereof.

Further, the said water purification unit includes a water inlet port and water outlet port. The said water inlet port is connected with a continuous water supply source and works as a water inlet for taking up the contaminated water inside of the said water purification system. The said water outlet port is adapted for dispensing purified water. Furthermore, the water purification unit also includes a waste water outlet port adapted for separating the waste water from the purified water.

Further, the present invented water purification system includes a plurality of sensors placed within the said water purification unit. The said plurality of sensors is adapted to detect a plurality of water property parameters and provide an output data related to the said plurality of water property parameters. The said plurality of sensors are selected from at least one of a turbidity sensor, a flow sensor, a pressure sensor, a total dissolve solid (TDS) sensor, an ultra violet light sensor, a temperature sensor, a pH sensor, a low pressure switch (LPS) sensor, a solenoid valve sensor, or a combination thereof.

Further, the present invented water purification system includes a micro controller unit (MCU) having a data processing module, a data storage unit, and a data transceiver module. The said data processing module includes an analog to digital converter (ADC) connected with the said plurality of sensors and an arithmetic logic unit (ALU) connected with the said ADC. The said ADC is adapted for converting the output data of the plurality of sensors into a digital value data which is further processed by the ALU into the specific data format.

The said specific data format is then forwarded to a data transceiver module adapted for transmitting the said output data to a remotely located diagnostic device. The said remotely located diagnostic device monitors a malfunctioning condition of the said water purification system and provides a set of diagnostic instructions to auto diagnose the said water purification system. Further, the transceiver module receives the set of diagnostic instructions from the said remotely located diagnostic device. The said data transceiver module and the remotely located diagnostic device works in conjugation with each other via a communication network.

In one embodiment, the present invented water purification system includes a notification module configured thereon, wherein the said notification module is connected to the said MCU and the said notification module is adapted to notify the output data from the said MCU to a user of the said water purification system.

Specifically, the said notification module includes a display screen adapted for displaying the digital value data of each of the plurality of water property values as measured by the plurality of sensors; and a plurality of switches adapted for operating the said MCU and the said water purification system, wherein the plurality of switches assist an user of the water purification system to monitor the malfunctioning condition of the said water purification system.

Accordingly, the present inventive water purification system monitors and notifies the malfunctioning conditions to the user as well as to a remotely located diagnostic device.

These aspects together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawing and descriptive matter in which there is illustrated an exemplary embodiment of the present invention.

### DESCRIPTION OF THE DRAWINGS

The advantages and features of the present invention will become better understood with reference to the following detailed description taken in conjunction with the accompanying drawings, in which:

FIG. 1 illustrates an exemplary block diagram of an auto diagnostic sensor based water purification system, according to various embodiments of the present invention.

FIG. 2 illustrates a flowchart for an exemplary process of an auto diagnostic sensor based water purification system, according to various embodiments of the present invention.

FIG. 3 illustrates exemplary environment showing communication between auto diagnostic sensors based water purification system and diagnostic device, according to various embodiments of the present invention.

FIG. 4 illustrates a flowchart of an exemplary process that occurs between auto diagnostic sensor based water purification system and diagnostic device, according to various embodiments of the present invention.

Like reference numerals refer to like parts throughout the description of several views of the drawing.

### DESCRIPTION OF THE INVENTION

The exemplary embodiments described herein detail for illustrative purposes are subjected to many variations. It should be emphasized, however, that the present invention is not limited to auto diagnostic sensor based water purification system. It is understood that various omissions and substitutions of equivalents are contemplated as circumstances may suggest or render expedient, but these are intended to cover the application or implementation without departing from the spirit or scope of the present invention.

Unless otherwise specified, the terms, which are used in the specification and claims, have the meanings commonly used in the field of water purification and monitoring of quality of water. Specifically, the following terms have the meanings indicated below.

The terms “a” and “an” herein do not denote a limitation of quantity, but rather denote the presence of at least one of the referenced item.

The terms “having”, “comprising”, “including”, and variations thereof signify the presence of a component.

The term “auto diagnostic sensor based water purification system” mentioned herein, refers to the system that removes undesirable chemicals, biological contaminants, suspended solids and gases from contaminated water, and is interchangeably referred to as “system” hereinafter.

The term “sensors” refers to a device used to measure various parameters of water and functioning of equipment used in water purification. The sensors include, but are not limited to, a turbidity sensor, a flow sensor, a pressure sensor, a total dissolve solid (TDS) sensor, an ultra violet light sensor, a temperature sensor, a low pressure switch (LPS) sensor, a pH sensor, or a solenoid valve sensor and the like.

The term “microcontroller” or “MCU” refers to components such as ADC, ALU, Memory, and the like embedded on a chip.

The term “data processing module” is interchangeably referred to as “ALU” hereinafter.

The term “data storage module” is interchangeably referred to as “memory” hereinafter.

The term “data transceiver module” is interchangeably referred to as “communication module” hereinafter.

The term “communication module” refers to transceiver that is utilized for communication between the auto diagnostic sensor based water purification system and Diagnostic device. The communication module includes components such as Subscriber Identity Module (SIM), antenna, Wi-Fi, LAN/WAN, and the like components utilized in communication. The communication module should be understood as having both wire as well as wireless communication compatibility.

The term “User Interface” or “UI” or interchangeably referred to as “notification module” refers to interface present on the auto diagnostic sensor based water purification system to inform user(s) regarding the functioning of the system and allows the user(s) to interact with the system.

Accordingly, many variations of these embodiments are envisaged within the scope of the present invention.

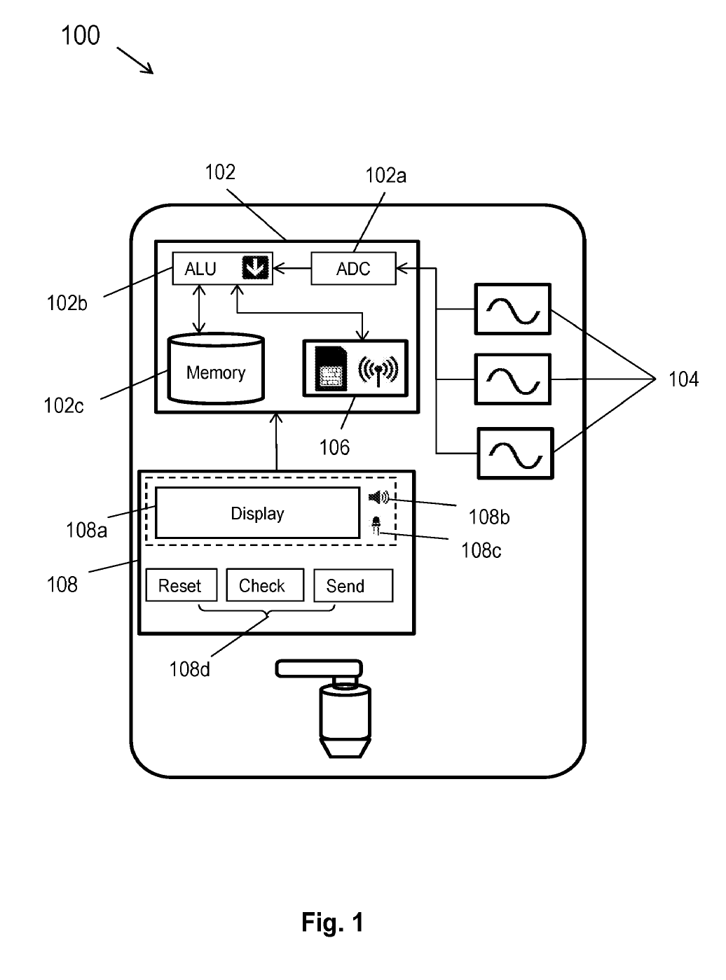

In an embodiment of the present invention, FIG. 1 illustrates an exemplary block diagram of an auto diagnostic sensor based water purification system 100. A plurality of sensors 104 is located in the system 100 at various purification levels/layers. The sensors 104 are used to provide different water parameters to the MCU 102. The water parameters include, but not limited to, total dissolved solid/particles per million (TDS/PPM), turbidity and the like.

The sensors 104, in addition to measuring water parameters, also monitor the functioning of various purification equipment of the system namely, ultraviolent (UV) layer, pressure pump, valves and the like. Water parameters sent by the sensors 104 is received by the MCU 102. The Analog to Digital Convertor (ADC) 102a converts the information/water parameters in a form that can be processed by the Arithmetic and Logic Unit (ALU) 102b. The unit 102b runs a program stored in the memory 102c of the MCU 102.

In an embodiment, the memory 102c is a non-volatile memory to store instructions, System 100 details, Address, Template form, and the like. The instructions/program stored in the memory 102c is utilized by the ALU 102b to check whether the water parameters sent by the sensors 104 satisfy pre-defined water parameters set by the manufacturer.

In an embodiment, the water parameters are set by end users such as the .

If the ALU 102b finds any discrepancy in the water parameters after processing, analyzed data is sent to the UI 108 and/or communication module 106. The formats of analyzed data sent to UI and communication module is different.

In an embodiment, the analyzed data sent to UI 108 is notified to the user by Display 108a, or LED 108c, or Alarm 108b or a combination thereof.

In another embodiment of the present invention, the analyzed data sent by the ALU 102b of the MCU 102 is sent to communication module 106. The module 106 is a transceiver also including a SIM to identify customer details. The module 106 sends the analyzed data to a remotely located Diagnostic device or support team.

In this way, automatically determines the functioning of the system 100 and sends info regarding the same to a remotely located device or support team for assistance if needed.

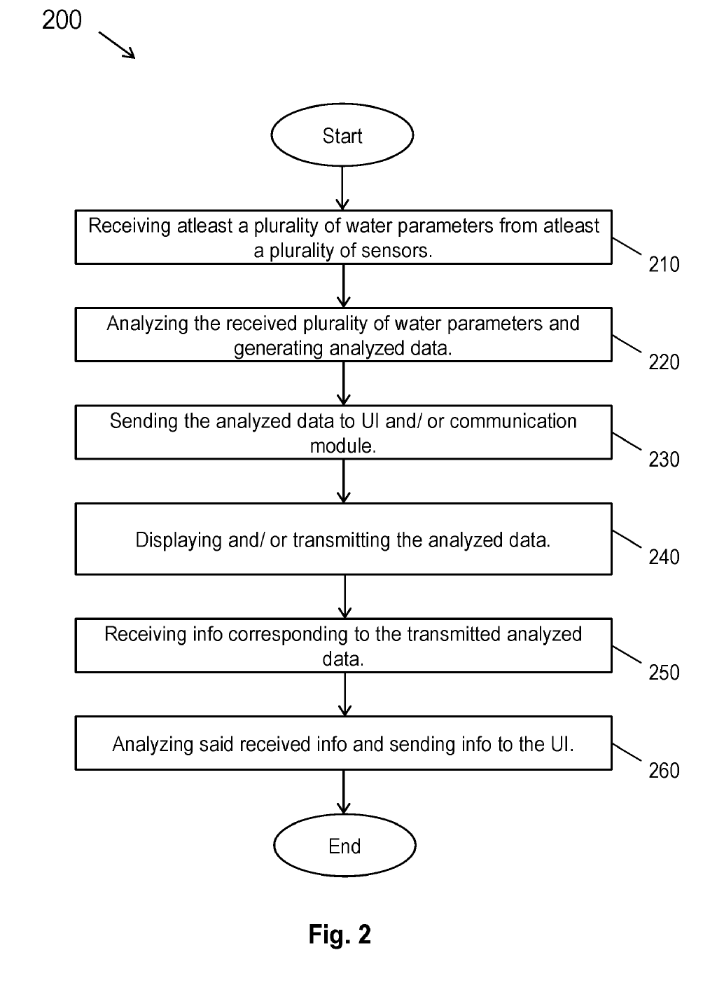

FIG. 2 illustrates a flowchart for an exemplary process 200 of an auto diagnostic sensor based water purification system. The process 200 starts at step 210 where at least a plurality of water parameters are received by the MCU from at least a plurality of sensors located in the system.

At step 220, the MCU analyzes the received plurality of water parameters. The plurality of water parameters are processed based on the instructions stored in the memory of the MCU. The analyzed data is organized in a format.

At step 230, the analyzed data is sent to UI and/or communication module. In an embodiment of the present invention, the format of the analyzed data sent to UI is different than format sent to communication module.

At step 240, the analyzed data is displayed on the UI. In another embodiment of the present invention, the analyzed data is transmitted by the communication module to a remotely located diagnostic device or support team.

In yet another embodiment of the present invention, the auto diagnostic sensor based water purification system receives information corresponding to the analyzed data sent by the communication module.

At step 250, the communication module of the system receives information corresponding to the analyzed data sent from the diagnostic device/support team.

The received information is then analyzed by the MCU and organized in format before sending it to UI at step 260. This way the information from the diagnostic device/support team notifies the end user of the situation or status of the auto diagnostic sensor based water purification system.

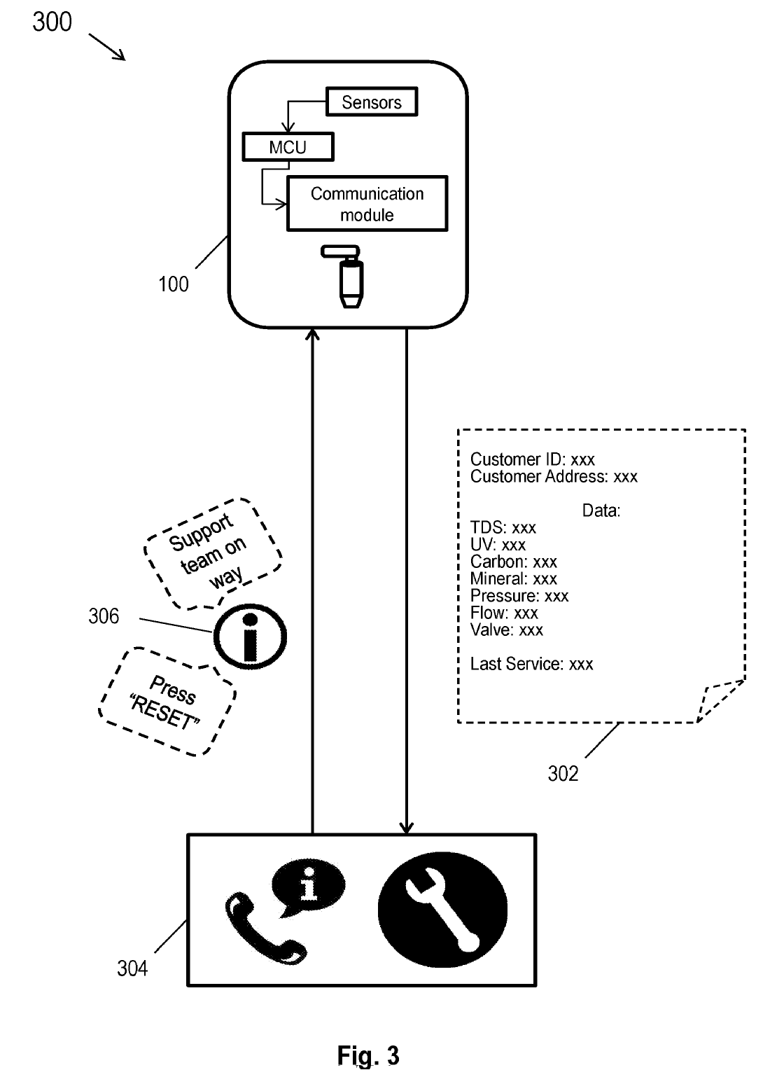

FIG. 3 illustrates exemplary environment 300 showing communication between auto diagnostic sensor based water purification system and diagnostic device/support team.

The environment 300 shows a scenario where the end users are notified of the status of the system 100 by the diagnostic device 304. In various embodiments of the present invention, the UI of the system 100 includes components like display screen 108a, LED 108c, Alarm 108b etc. In addition, the UI also includes tab keys/buttons for the end user to check the status of the system manually and call for assistance based on their will.

In an embodiment of the present invention, the system automatically diagnoses itself and transmits the data to the remotely located diagnostic device/support team 304.

The environment 300 will be better understood with block diagram of FIG. 1 and process involved therein illustrated in FIG. 2. The sensors in the system 100 send the water parameters to the MCU which are processed based on pre-programmed parameters and converted to analyzed data. The analyzed data is sent to the communication module which transmits it to the diagnostic device 304.

In an exemplary embodiment, the sent analyzed data 302 contains information regarding the end user/customer and data relating to existing water parameters of the system.

In an embodiment of the present invention, the analyzed data is sent via wireless communication such as short message service (SMS).

The diagnostic device/support team 304 reviews the analysed data received from the system 100. The device/team 304 generate information corresponding to the analysed data and sends it to the system 100. In an exemplary embodiment of the present invention, the information sent 306 is a text such as “Support team on way”, or “Press RESET” and the like as illustrated in FIG. 3.

The information 306 is received by the system 100 via the communication module. The said information 306 is later displayed on the UI of the system.

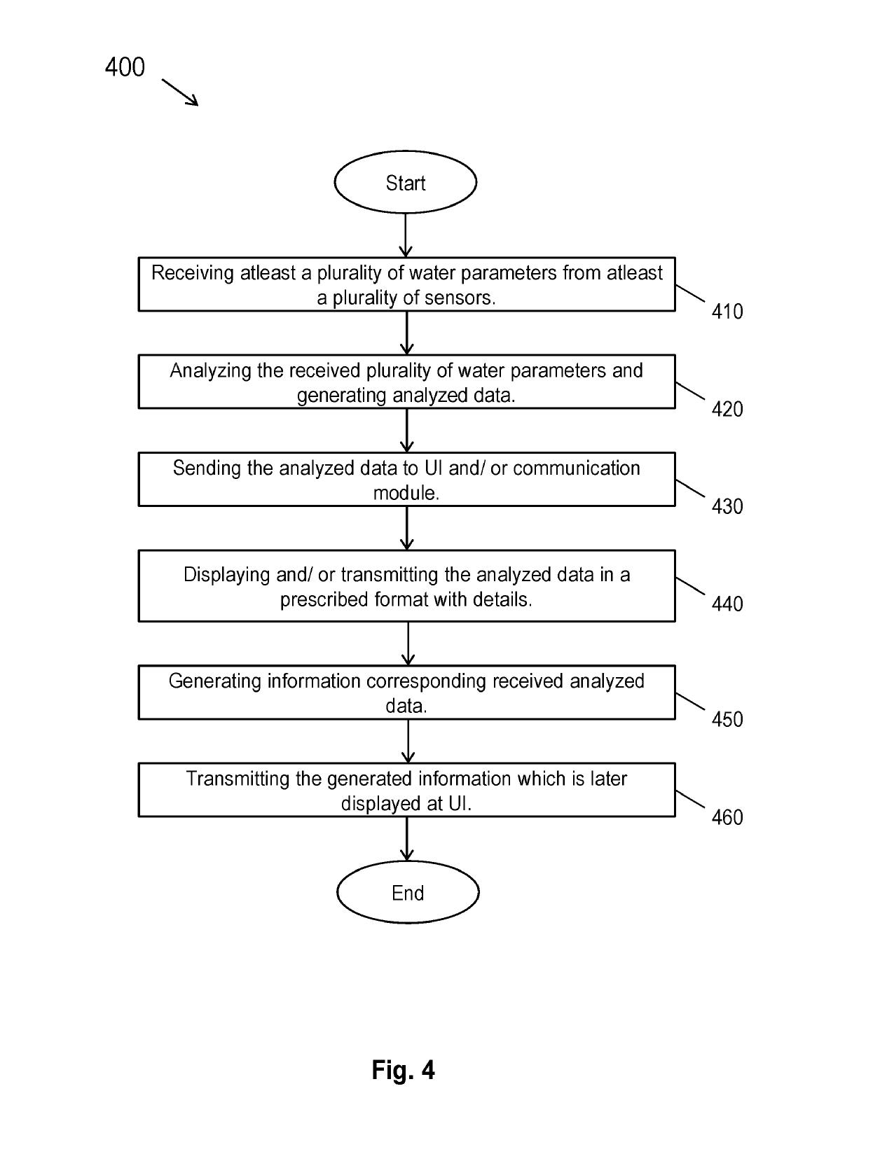

FIG. 4 illustrates a flowchart of an exemplary process 400 that occurs between auto diagnostic sensor based water purification system and diagnostic device.

The process 400 starts at step 410, where the sensors in the system provide water parameters to the MCU. The information contained in water parameters is related to quality of water during purification including, but not limited to, total dissolve solid (TDS), minerals and the like. The water parameters further include information related to turbidity, pH, flow, pressure, UV, temperature etc. Furthermore, the sensors also provide “pH value” as one of the water parameters.

The water attributes provided to the MCU are converted into digital signals by the ADC so that ALU can process them. This is done at step 420 where the water attributes are processed by the ALU according to the pre-programmed instructions stored in the memory and analysed data is generated.

At step, 430 this analysed data is sent to the UI and/or communication module. The following step 440, the UI displays the analysed data and/or communication module transmits the analysed data to a remotely located diagnostic device/support team. In an embodiment of the present invention, the analysed data transmitted is sent in a different format which is stored in the memory.

In another embodiment, the communication module uses wire and/or wireless communication to transmit the analysed data. In an implementation, the communication module has a Wi-Fi antenna and is connected to a Wi-Fi network. In such a case, the sent analyzed data can be in form of electronic mail.

In yet another embodiment of the present invention, the UI of the system includes a display screen 108a, an LED 108c, alarm 108b for notifying the end user regarding the status of the system. In an implementation the LED turns “RED” when the quality of purified water or water parameters doesn't match with the pre-programmed instructions of the MCU.

In yet another embodiment of the present invention, the LED is adapted for indicating a critical malfunctioning condition of the water purification system. The said critical malfunctioning condition is selected from any one of the malfunctioning of the ultra violet component, malfunctioning of the reverse osmosis component, malfunctioning of the mineral dispenser component, malfunctioning of the odour treatment component, malfunctioning of the pH correction component, malfunctioning of the taste improvement component, or malfunctioning of the color treatment component.

In addition to the “RED” LED, the alarm of the UI is turned on when there is a highly critical malfunctioning condition of the water purification system. The said highly critical malfunctioning condition is selected when the filtration membrane and/or carbon filter is almost ruptured and/or damaged. In case, if there is damage to any of the components of the system say RO membrane and/or carbon filter then the sensors would provide this information to the MCU and similarly “Highly Critical Malfunction” message is displayed on the display screen. Further, alarm is sound in such a case.

Apart from the above mentioned advantages of the present system, it is further beneficial for someone who hardly checks the system manually. As the system generates analyzed data that is sent both to the communication module and UI, in case of communication failure the UI still works. Hence, the user would be notified by various means such as display of messages on display screen, say “RED” colored LED, sound of the alarm.

In yet another embodiment of the present invention, the said LED 108c along with the alarm 108b is adapted to provide the easy notification in the form of light and sound signals to an illiterate user. Further, said LED 108c along with the alarm 108b is helpful to provide manual notification to the remotely located diagnostic device in case there is breakdown of the entire communication network as provided to make an auto communication between the water purification system and the remotely located diagnostic device.

At step 450, the analysed data is received by the diagnostic device/support team and information is generated based on it. The information is then sent to the system at step 460. Also, the information sent when received by the system is displayed via UI of the system.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present invention.

What is claimed is:

1. An auto diagnostic sensor based water purification system, the said water purification system comprising:
a water purification unit adapted to purify the contaminated water;
a plurality of sensors placed within the said water purification unit, wherein the plurality of sensors are adapted to detect a plurality of water property parameters and provide an output data related to the said plurality of water property parameters; and
a micro controller unit (MCU) connected with the said plurality of sensors, wherein the said MCU is adapted to process the said output data and send it to a remotely located diagnostic device, wherein the said remotely located diagnostic device monitors a malfunctioning condition of the said water purification system and provides a set of diagnostic instructions to auto diagnose the said water purification system.

2. The auto diagnostic sensor based water purification system as claimed in claim 1, wherein the water purification unit is made up of one of a water treatment component, wherein the said water treatment component is selected from a filtration membrane component, an ultraviolet component, a reverse osmosis component, a mineral dispenser component, an odour treatment component, a pH correction component, a taste improvement component, or a color treatment component.

3. The auto diagnostic sensor based water purification system as claimed in claim 1, wherein the water purification unit comprises a water inlet port adapted as a water inlet for taking up the contaminated water inside of the said water purification system and a water outlet port adapted for dispensing purified water.

4. The auto diagnostic sensor based water purification system as claimed in claim 1, wherein the said plurality of sensors are selected from at least a turbidity sensor, a flow sensor, a pressure sensor, a total dissolve solid (TDS) sensor, an ultra violet light sensor, a temperature sensor, a low pressure switch (LPS) sensor, a pH sensor, or a solenoid valve sensor.

5. The auto diagnostic sensor based water purification system as claimed in claim 1, wherein the said MCU comprises:
a data processing module adapted to process the said output data of the said plurality of sensors into a specific data format;
a data storage unit for storing the said output data and the said specific data format; and
a data transceiver module adapted for transmitting the said output data to the remotely located diagnostic device and receiving the set of diagnostic instructions from the said remotely located diagnostic device, wherein the said data transceiver module works in conjugation with the remotely located diagnostic device via a communication network selected from at least a cellular network, a radio network, an internet network, a wired network, or a wireless network.

6. The auto diagnostic sensor based water purification system as claimed in claim 5, wherein the data processing module comprises:
an analog to digital converter (ADC) adapted for converting the output data into a digital value data; and
an arithmetic logic unit (ALU) connected with the said ADC, wherein the said ALU processes the digital value data in the specific data format.

7. The auto diagnostic sensor based water purification system as claimed in claim 5, wherein the data transceiver module comprises:
a data transmitter adapted for transmitting the output data to the remotely located diagnostic device;
a data receiver adapted for receiving the set of diagnostic instructions from the remotely located diagnostic device; and
an integrated circuit chip adapted for storing an identification key of the said water purification system, wherein the said identification key comprises an identification dataset selected from a name of a customer, a location of a customer, a warranty time period of the water purification system, a model number of the water purification system, or a date of manufacture of the water purification system.

8. The auto diagnostic sensor based water purification system as claimed in claim 5, wherein the said communication network is selected from the cellular network.

9. The auto diagnostic sensor based water purification system as claimed in claim 1 further comprises a notification module configured thereon, wherein the said notification module is connected to the said MCU and the said notification module is adapted to notify the output data from the said MCU to a user of the said water purification system.

10. The auto diagnostic sensor based water purification system as claimed in claim 9, wherein the notification module comprises:
a display screen adapted for displaying the digital value data of each of the plurality of water property parameters as measured by the plurality of sensors;
a light emitting diode indicator (LED) adapted for indicating a critical malfunctioning condition of the water purification system;
a sound alarm adapted for indicating a highly critical malfunctioning condition of the water purification system; and
a plurality of tab keys adapted for operating the said MCU and the said water purification system, wherein the plurality of tab keys assist the user to give commands to and/or communicate with the auto diagnostic sensor based water purification system.
